(19) United States
(12) Patent Application Publication
(10) Pub. No.: US 2007/0273616 A1
(43) Pub. Date: Nov. 29, 2007

(54) Driving method for plasma display apparatus

(75) Inventors: Jong-Woon Kwak, Anyang-si (KR); Taehyung Kim, Seoul (KR); Woong-Kee Min, Yongin-si (KR); Seonghak Moon, Seoul (KR); Oedong Kim, Seongnam-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/802,865

(22) Filed: May 25, 2007

(30) Foreign Application Priority Data
May 26, 2006 (KR) 10-2006-0047832

(51) Int. Cl. G09G 3/28

(52) U.S. Cl. 345/60

(57) ABSTRACT

A driving method for a plasma display apparatus is provided. In the method, a first pulse is applied to a first electrode in a positive direction and a second pulse is applied to the first electrode in a negative direction alternately during the sustain period. a predetermined bias voltage is applied to a second electrode during applying the a first pulse to a first electrode in a positive direction and a second pulse to the first electrode in a negative direction. Then, a rising period of the first pulse is shorter than a falling period of the second pulse.

This Nonprovisional application claims priority under 35 U.S.C. §119(a) on Patent Application No. 10-2006-0047832 filed in Korea on May 26, 2006 the entire contents of which are hereby incorporated by reference.

### BACKGROUND

1. Field

This document relates to a driving method for a plasma display apparatus.

2. Related Art

In general, a plasma display apparatus includes a plasma display panel for displaying images and a driver disposed at the rear surface of the plasma display panel for driving the plasma display panel.

The plasma display panel includes an upper substrate, a lower substrate separated from the upper substrate at a predetermined distance, and a barrier rib formed between the upper substrate and the lower substrate for forming a plurality of discharging cells. Each cell is filled with a discharge gas such as neon (Ne), helium (He), or a mixture (Ne+He) of neon and helium, and Inert gas containing a small quantity of xenon (Xe). A pixel is formed of the discharge cells, a red discharge cell R, a green discharge cell G, and a blue discharge cell.

If the inert gas is discharged using a high frequency voltage, ultraviolet rays are generated. The ultra-violet rays which are invisible to the human eye, excite light-emitting phosphors in each cell.

The plasma display panel includes a plurality of electrodes, for example, scan electrodes Y, sustain electrodes Z, and address electrodes X. The electrodes are connected to corresponding drivers for supplying a driving voltage to the electrodes of the plasma display panel.

While the plasma display panel is driving, each of the drivers supplies a corresponding driving pulse to the electrodes of the plasma display panel at a predetermined period to excite the discharge cells. For example, the drivers supplies a reset pulse to the scan electrodes Y, during a reset period and supplies a scan pulse to the scan electrodes Y, during an address period and alternately supplies a sustain pulse to the scan electrode Y, or the sustain electrodes Z during a sustain period.

A plasm display apparatus can be made thin and slim, and has thus been in the spotlight as the present-generation of display devices.

### SUMMARY

An aspect of this document is to provide a method of driving a plasma display apparatus for reducing brightness difference generated between electrode lines while a plasma display panel is driving.

Another aspect of this document is to provide a method of driving a plasma display apparatus for driving a plasma display panel with low cost.

Still another aspect of this document is to provide a method of driving a plasma display apparatus for embodying stable sustain discharge when a plasma display panel is driven.

In one aspect, a method of driving a plasma display apparatus by dividing one subfield into at least an address period and a sustain period is provided. In the method, a first pulse is applied to a first electrode in a positive direction and a second pulse is applied to the first electrode in a negative direction alternately during the sustain period. A predetermined bias voltage is applied to a second electrode during applying the first pulse to a first electrode in a positive direction and a second pulse to the first electrode in a negative direction. Then, a rising period of the first pulse is shorter than a falling period of the second pulse.

Implementations may include one or more of the following features. For example, a rising period of the first pulse ranges from about 300 ns to about 1 ms.

A ratio of the rising period of the first pulse to the falling period of the second pulse ranges from about 1:1.2 to about 1:1.5.

A positive polarity pulse may be applied to a third electrode during the sustain period.

A positive polarity pulse may be applied to the third electrode while the first pulse is applied to the first electrode in the positive direction.

In another aspect, a method of driving a plasma display apparatus by dividing one subfield into at least an address period and a sustain period is provided. In the method, a first pulse is applied to a first electrode in a positive direction and a second pulse is applied to the first electrode in a negative direction alternately during the sustain period. A predetermined bias voltage is applied to a second electrode during applying the first pulse to a first electrode in a positive direction and a second pulse to the first electrode in a negative direction. Then, a bias period of the first pulse is shorter than a bias period of the second pulse.

Implementations may include one or more of the following features. For example, a bias period of the first pulse ranges from about 500 ns to about 2 ms.

A ratio of the bias period of the first pulse to the bias period of the second pulse ranges from 1:1.3 to 1:1.8.

In still aspect, a method of driving a plasma display apparatus by dividing one subfield into at least an address period and a sustain period is provided. In the method, a first pulse is applied to a first electrode in a positive direction and a second pulse is applied to the first electrode in a negative direction alternately during the sustain period. A predetermined bias voltage is applied to a second electrode during applying the first pulse to a first electrode in a positive direction and a second pulse to the first electrode in a negative direction. Then, a rising period of the first pulse is shorter than a falling period of the second pulse and a bias period of the first pulse is shorter than a bias period of the second pulse.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 illustrates a schematic diagram of a plasma display device according to an embodiment;

FIG. 2 illustrates a timing diagram of a driving waveform supplied to a plasma display panel according to an embodiment;

FIG. 3a and 3b illustrate a timing diagram of a driving pulse supplied to scan electrodes and sustain electrodes in a sustain period of FIG. 2 according to a first embodiment;

FIG. 4 illustrates a timing diagram of a driving pulse supplied to scan electrodes and sustain electrodes in a sustain period of FIG. 2 according to the second embodiment;

FIG. 5 illustrates a timing diagram of a driving waveform supplied to a plasma display panel according to another embodiment; and

FIG. 6 illustrates an electric field intensity formed surrounding a scan electrode and a sustain electrode according to embodiment.

### DETAILED DESCRIPTIONS

Hereinafter, an implementation of this document will be described in detail with reference to the attached drawings.

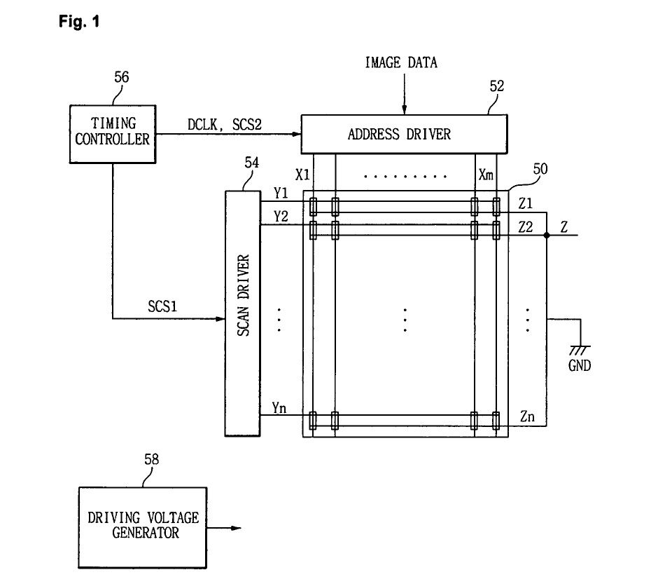

FIG. 1 illustrates a schematic diagram of a plasma display device according to an embodiment.

Referring to FIG. 1, the plasma display apparatus according to the present embodiment comprises a plasma display panel 50, an address driver 52, a scan driver 54, a timing controller 56, and a driving voltage generator 58.

The plasma display panel 50 comprises a plurality of first electrode Y1 to Yn, and a plurality of second electrode Z1 to Zn, which are arranged in a column direction, and a plurality of third electrodes X1 to Xn arranged in a row direction. The first electrodes Y1 to Yn denote scan electrodes, the second electrode Z1 to Zn denotes sustain electrodes, and the third electrode X1 to Xm denote address electrodes, hereinafter.

The address driver 52 is controlled by a data clock DCLK and a second switching control signal SCS2 outputted from the timing controller 56 and supplies image data from an external device to the address electrodes X1 to Xm.

The scan driver 54 supplies a reset pulse and a scan pulse to the scan electrodes Y1 to Ym according to the first switching control signal SCS1 supplied from the timing controller 56. The scan driver 54 alternatively supplies a positive sustain pulse as a first pulse and a negative sustain pulse as a second pulse to the scan electrodes Y1 to Ym in order to induce a sustain discharge with the sustain electrodes Z1 to Zn that always receive bias voltage, preferably, a ground voltage GND.

The sustain electrodes Z1 to Zn disposed at the plasma display panel 50 are connected to a ground voltage source GND. That is, the plasma display apparatus does not comprise a driver for driving the sustain electrodes. Therefore, the manufacturing cost of the plasma display apparatus can be reduced. The plasma display apparatus may surely comprise a driver for driving the sustain electrodes for supplying a predetermined bias voltage to the sustain electrode.

The driving voltage generator 58 generates various driving voltages to generate a predetermined driving waveform, and supplies the generated driving voltage to the address driver 52 and the scan driver 54.

The timing controller 56 generates various switching control signals for generating a predetermined driving waveform and supplies the generated switching control signals to the address driver 52 and the scan driver 54. For example, the timing controller 56 generates a first switching signal SCS1 and supplies the generated first switching signal to the scan driver 54. The timing controller 56 generates the second control signal SCS2 and the data clock DCLK and supplies the second control signal SCS2 and the data clock DCLK to the address driver 52.

Hereinafter, a method of driving a plasma display apparatus according to an embodiment will be described.

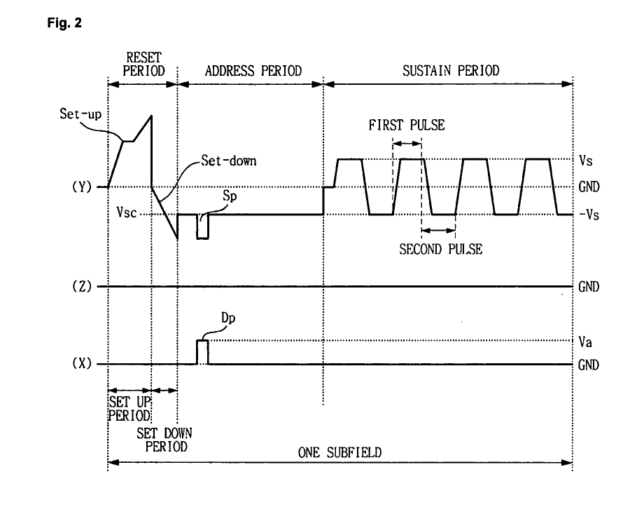

FIG. 2 illustrates a timing diagram of a driving waveform supplied to a plasma display panel according to an embodiment.

As shown in FIG. 2, in the method of driving a plasma display apparatus according to the present embodiment, a driving pulse is supplied to each of the electrodes X1 to Xm, Y1 to Yn, and Z1 to Zn by dividing one sub fields into a reset period for initializing the cells of the plasma display panel 50, an address period for selecting cells to discharge, and a sustain period for sustaining the selected cells to discharge in order to display images.

In the reset period or the setup period, a set-up pulse may be supplied to the scan electrodes Y1 to Yn of the plasma display panel 50. The set-up pulse induces a weak discharge in a discharge cell of the plasma display panel. In the set-down period, a set-down pulse falling from a sustain voltage Vs level to a predetermined voltage level may be supplied to the scan electrodes Y1 to Yn. Positive wall charge and negative wall charge can be sufficiently removed from a cell by inducing an erasing discharge between the scan electrodes Y1 to Yn and the address electrode X1 to Xm.

In the address period, a negative scan pulse falling from a scan reference voltage (Vsc) may be supplied to the scan electrodes Y1 to Yn. Furthermore, positive data pulse corresponding to the described scan pulse can be supplied to the address electrodes X1 to Xn. As the voltage difference between the scan pulse and the data pulse is added to the wall voltage generated in the reset period, an address discharge is induced in a discharge cell that receives the data pulse. The wall charge just enough for inducing the discharge is formed at a discharge cell selected by the address discharge when the sustain voltage (Vs) is supplied.

In the sustain period, the first pulse and the second pulse are alternately supplied to the scan electrodes Y1 to Yn. A predetermined bias voltage may be supplied to the sustain electrodes Z1 to Zn. Preferably, the sustain electrodes Z1 to Zn may sustain a ground level.

By sustaining the sustain electrode to have a predetermined bias voltage as described above, a driving circuit for driving the sustain electrodes can be shortened. Therefore, the manufacturing cost can be reduced.

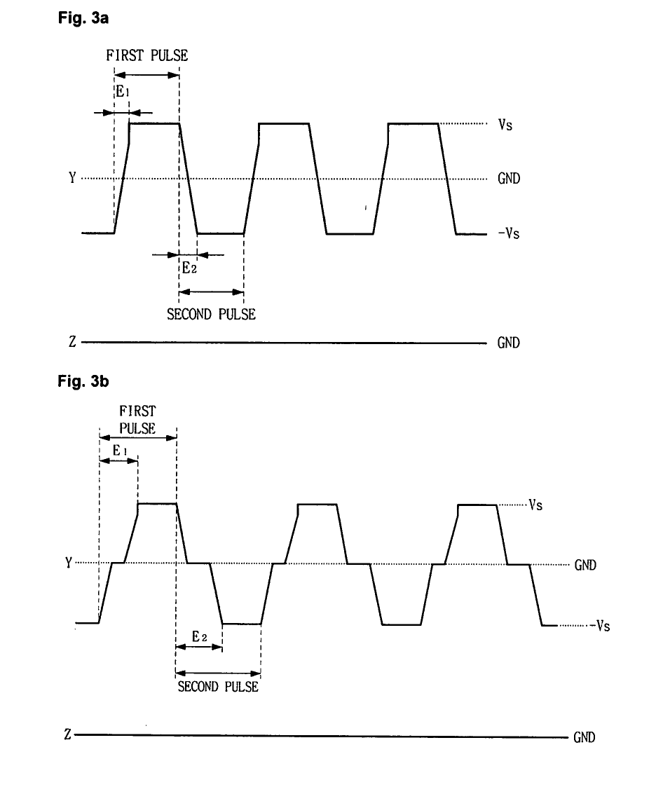

As shown in FIG. 3a, the first pulse is a pulse that arises from a negative voltage −Vs to a positive sustain voltage Vs and sustains at the positive sustain voltage Vs for a predetermined time. The second pulse is a pulse that falls from the positive sustain voltage Vs to the negative voltage -Vs and sustains at the negative voltage −Vs for a predetermined time.

Further, as shown in FIG. 3b, the first pulse may be a pulse that arises from a negative voltage −Vs to a ground level voltage GND and maintains at the ground level voltage GND for a predetermined time, and arises from the ground level voltage GND to a positive sustain voltage Vs and maintains at the positive sustain voltage Vs for a predetermined time. Also, the second pulse may be a pulse that falls from the positive sustain voltage Vs to a ground level voltage GND and maintains at the ground level voltage GND for a predetermined time, and falls from the ground level voltage GND to the negative voltage −Vs and maintains at the negative voltage −Vs for a predetermined time.

Hereinafter, the first and second pulses will be described in more detail with reference to FIG. 3a and FIG. 3b.

Although it is not shown in the accompanying drawings, an erasing period may be included after the sustain period in order to erase a wall charge after inducing the sustain discharge at a scan electrode or a sustain electrode.

FIG. 3a and FIG. 3b illustrate a timing diagram of a driving pulse supplied to scan electrodes and sustain electrodes in a sustain period of FIG. 2 according to a first embodiment.

Referring to FIGS. 3a and 3b, in the sustain period, the first pulse is supplied to the scan electrode and the second pulse is supplied to the first electrode, alternatively, and the sustain electrode sustains a ground level.

In this case, the raising period El of the first pulse that raises from a negative voltage −Vs to a positive sustain voltage Vs is shorter than the falling period E2 of the second pulse that falls from the positive sustain voltage Vs to the negative voltage −Vs.

The raising period of the first pulse can be differently setup according to the driving characteristics of the plasma display panel such as a discharge characteristic of phospers. The driving characteristic of the plasma display panel, however, can be effectively improved by setting up the raising time of the first pulse longer than 300 ns and shorter than 1 ms.

The ratio between the raising period of the first pulse and the falling period of the second pulse can be differently setup according to the driving characteristics of the plasma display panel. The driving margin of the plasma display panel can be further secured by setting up the ratio between the raising period of the first pulse and the falling period of the second pulse to be larger than 1:1.2 and smaller than 1:1.5.

The raising period E1 or the falling period E2 can be expressed as a slop of a corresponding pulse. That is, it can be expressed as the absolute value of the slop of the first pulse is larger than that of the second pulse.

As described above, the brightness difference between electrode lines can be even further compensated by supplying the first pulse having the raising period E1 shorter than the falling period E2 of the second pulse to the scan electrodes.

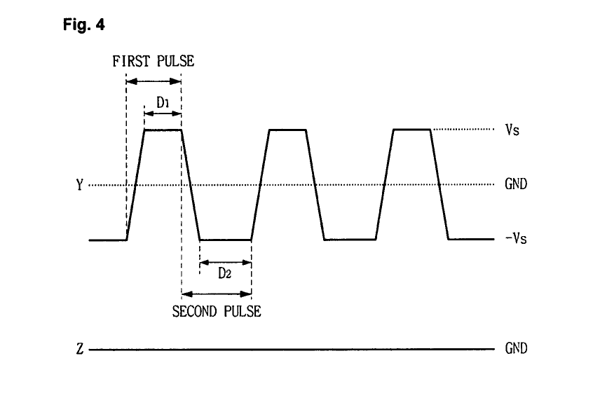

FIG. 4 illustrates a timing diagram of a driving pulse supplied to scan electrodes and sustain electrodes in a sustain period of FIG. 2 according to the second embodiment

Referring to FIG. 4, in the sustain period, the first pulse is supplied to the scan electrodes and the second pulse is supplied to the first electrode, alternately, and the sustain electrodes maintain the predetermined bias voltage.

A magnitude of the predetermined bias voltage can be differently setup according to the driving characteristics of the plasma display panel. A manufacturing cost can be reduced by setting the magnitude of the predetermined bias voltage to be the ground level voltage. Because a driving circuit for driving the sustain electrodes can be shortened.

In this case, a first pulse bias period D1 where the first pulse sustains at the positive sustain voltage Vs is shorter than a second pulse bias period D2 where the second pulse sustains at the negative voltage −Vs.

The first pulse bias period D1 also can be setup differently according to the driving characteristics of the plasma display panel such as a discharge characteristic of phospers. The driving characteristic of the plasma display panel, however, can be effectively improved by setting up the first pulse bias period D1 longer than 500 ns and shorter than 2 ms.

Also, the ratio between the first pulse bias period D1 and the second pulse bias period D2 can be differently setup according to the driving characteristics of the plasma display panel. The driving margin of the plasma display panel can be further secured by setting up the ratio between the first pulse bias period and the second pulse bias period to be larger than 1:1.3 and smaller than 1:1.8.

As described above, the brightness difference between electrode lines can be even further compensated by supplying the first pulse having the bias period D1 shorter than the second pulse bias period D2 to the scan electrodes.

In the certain embodiment, the first pulse and the second pulse are alternately supplied to the scan electrodes and the sustain electrodes sustains the ground level in the sustain period. However, it is possible to supply the first pulse and the second pulse to the sustain electrodes and to sustain the scan electrodes at the ground level.

In the certain embodiment of the present invention, the driving pulse is supplied to the scan electrodes the raising time and the falling time of the driving pulse are controlled and supplied to the scan electrodes, and the bias period of the driving pulse is controlled and supplied to the scan electrodes, independently in the sustain period. However, the brightness difference between electrode lines or the driving characteristics of the plasma display panel can be further improved by controlling the raising time, the falling time, and the bias period of the driving pulse at the same time and supplying them to the scan electrodes.

The driving pulse according to the embodiments can be applied to a plasma display panel which has not only an electrode arrangement, scan electrode—sustain electrode—scan electrode—sustain electrode YZYZ, but also to other electrode arrangements, scan electrode—scan electrode—sustain electrode—sustain electrode YYZZ.

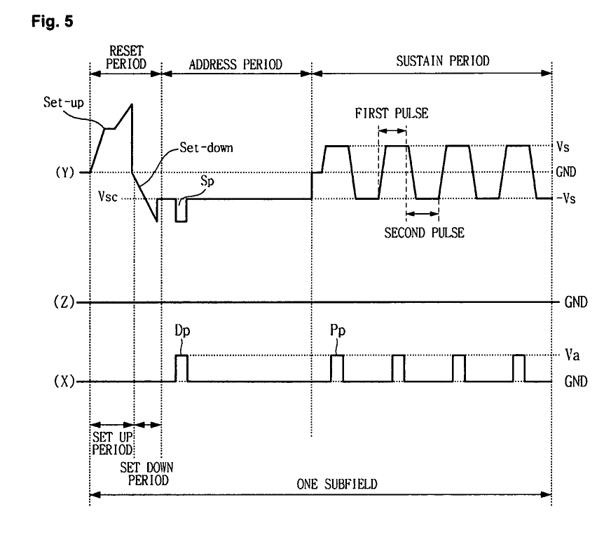

FIG. 5 illustrates a timing diagram of a driving waveform supplied to a plasma display panel according to another embodiment.

Referring to FIG. 5, driving waveforms supplied to the plasma display panel according to another embodiment in the reset period and the address period are identical to that shown in FIG. 2. Therefore, the descriptions of the driving waveform supplied in the reset period and the address period are omitted.

On the contrary, in the sustain period, the first pulse and the second pulse is applied to the scan electrodes alternately and the sustain electrodes maintain the ground level voltage and a positive polarity pulse Pp is applied to the address electrodes.

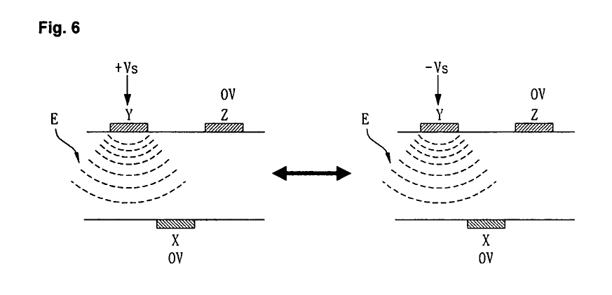

In the sustain period, the first pulse having a positive sustain voltage Vs and the second pulse having a negative sustain voltage −Vs are applied to the scan electrode alternately so that an electric field intensity is strongly formed surrounding the scan electrode as show in FIG.6. The electric field intensity induces to genetrate facing discharge between the scan electrode and the address electrode instead of surface discharge between the scan electrode and the sustain electrode. Therefore, a surface discharge is unstably generated between the scan electrode and the sustain electrode during the sustain period.

To apply the positive polarity pulse Pp to the address electrode interrupts generating the facing discharge between the scan electrode and the address electrode. As a result, the stable surface discharge between the scan electrode and the sustain electrode is generated.

In this case, the positive polarity pulse may be applied to the address electrode while the first pulse is applied to the scan electrode in the positive direction. An electric field of the same polarity is formed surrounding the scan electrode and the address electrode thereby so that it can induce generating the surface discharge between the scan electrode and the sustain electrode. Accordingly, the stable surface discharge between the scan electrode and the sustain electrode is further generated.

Although it is not shown in the accompanying drawings, a negative polarity pulse may be applied to the address electrode during the sustain period while the second pulse is applied to the scan electrode in negative direction.

An absolute value of the voltage of the above positive polarity pulse or the above negative polarity pulse is less than the voltage of the first pulse and the second pulse. Preferably, an absolute value of the voltage of the positive polarity pulse or the negative polarity pulse is substantially equal to a magnitude of a voltage of a data pulse which is applied to the second electrode during an address period.

Therefore, a cost of the driving circuit to drive the plasma display panel is reduced.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A method of driving plasma display apparatus being driven by dividing a subfield into at least an address period and a sustain period, the method comprising:
applying alternately a first pulse to a first electrode in a positive direction and a second pulse to the first electrode in a negative direction during the sustain period;
applying a predetermined bias voltage to a second electrode during applying the a first pulse to a first electrode in a positive direction and a second pulse to the first electrode in a negative direction,
wherein a rising period of the first pulse is shorter than a falling period of the second pulse.

2. The method of claim 1, wherein the rising period of the first pulse ranges from about 300 ns to about 1 ms.

3. The method of claim 1, wherein a ratio of the rising period of the first pulse to the falling period of the second pulse ranges from about 1:1.2 to about 1:1.5.

4. The method of claim 1, wherein a positive polarity pulse is applied to a third electrode during the sustain period.

5. The method of claim 4, wherein the positive polarity pulse is applied to the third electrode while the first pulse is applied to the first electrode in the positive direction.

6. The method of claim 4, wherein a magnitude of a voltage of the positive polarity pulse is substantially equal to a magnitude of a voltage of a data pulse which is applied to the second electrode during an address period.

7. The method of claim 1, wherein the predetermined bias voltage is substantially a ground level voltage.

8. A method of driving plasma display apparatus being driven by dividing a subfield into at least an address period and a sustain period, the method comprising:
applying alternately a first pulse to a first electrode in a positive direction and a second pulse to the first electrode in a negative direction during the sustain period;
applying a predetermined bias voltage to a second electrode during applying the a first pulse to a first electrode in a positive direction and a second pulse to the first electrode in a negative direction,
wherein a bias period of the first pulse is shorter than a bias period of the second pulse.

9. The method of claim 8, wherein the bias period of the first pulse ranges from about 500 ns to about 2 ms.

10. The method of claim 8, wherein a ratio of the bias period of the first pulse to the bias period of the second pulse ranges from 1:1.3 to 1:1.8.

11. The method of claim 8, wherein a positive polarity pulse is applied to a third electrode during the sustain period.

12. The method of claim 11, wherein the positive polarity pulse is applied to the third electrode while the first pulse is applied to the first electrode in the positive direction.

13. The method of claim 11, wherein a magnitude of a voltage of the positive polarity pulse is substantially equal to a magnitude of a voltage of a data pulse which is applied to the second electrode during an address period.

14. The method of claim 8, wherein the predetermined bias voltage is substantially a ground level voltage.

15. A method of driving plasma display apparatus being driven by dividing a subfield into at least an address period and a sustain period, the method comprising:
applying alternately a first pulse to a first electrode in a positive direction and a second pulse to the first electrode in a negative direction during the sustain period;
applying a predetermined bias voltage to a second electrode during applying the a first pulse to a first electrode in a positive direction and a second pulse to the first electrode in a negative direction,
wherein a rising period of the first pulse is shorter than a falling period of the second pulse and a bias period of the first pulse is shorter than a bias period of the second pulse.

16. The method of claim 15, wherein the rising period of the first pulse ranges from about 300 ns to about 1 ms.

17. The method of claim 15, wherein a ratio of the rising period of the first pulse to the falling period of the second pulse ranges from about 1:1. 2 to about 1:1. 5.

18. The method of claim 15, wherein the bias period of the first pulse ranges from about 500 ns to about 2 ms.

19. The method of claim 15, wherein a ratio of the bias period of the first pulse to the bias period of the second pulse ranges from 1:1. 3 to 1:1. 8.

20. The method of claim 15, wherein a positive polarity pulse is applied to a third electrode during the sustain period.

21. The method of claim 20, wherein the positive polarity pulse is applied to the third electrode while the first pulse is applied to the first electrode in the positive direction.

22. The method of claim 20, wherein a magnitude of a voltage of the positive polarity pulse is substantially equal to a magnitude of a voltage of a data pulse which is applied to the second electrode during an address period.

23. The method of claim 15, wherein the predetermined bias voltage is substantially a ground level voltage.
